(19) United States
(12) Patent Application Publication
(10) Pub. No.: US 2014/0216918 A1
(43) Pub. Date: Aug. 7, 2014

(54) METHOD FOR FABRICATING GOLD/TITANIUM DIOXIDE CORE-SHELL STRUCTURED PHOTOCATALYST AND APPLICATION THEREOF TO PHOTOCATALYTIC DECOMPOSITION OF ORGANIC COMPOUNDS

(71) Applicant: BIOPTIK TECHNOLOGY, INC., Miaoli County (TW)

(72) Inventors: Chin-Chang YANG, Miaoli County (TW); YU-WEN CHEN, Miaoli County (TW); YAO-JEN TU, Miaoli County (TW); Jia-Long Jiang, Miaoli County (TW)

(73) Assignee: BIOPTIK TECHNOLOGY, INC., Miaoli County (TW)

(21) Appl. No.: 13/757,224

(22) Filed: Feb. 1, 2013

(51) Int. Cl. B01J 23/52; B01J 19/12

(52) U.S. Cl. CPC B01J 23/52; B01J 19/123
USPC 204/157.15; 502/344

(57) ABSTRACT

This invention discloses a method for fabricating a gold/titanium dioxide core-shell structured photocatalyst and the application thereof to photocatalytic decomposition of organic compounds under ultraviolet irradiation. The method comprises steps: fabricating a solution of gold ions; fabricating gold/titanium dioxide core-shell structured nanoparticles; and crystallizing the gold/titanium dioxide core-shell structured nanoparticles, wherein gold and titanium dioxide are mixed by a weight ratio of 0.005 to 0.03. The gold/titanium dioxide core-shell structured photocatalyst can effectively decompose organic compounds and dyes under ultraviolet irradiation.

### FIELD OF THE INVENTION

The present invention relates to a gold/titanium dioxide core-shell structure, particularly to a method for fabricating a gold/titanium dioxide core-shell structured photocatalyst and an application thereof to photocatalytic decomposition of organic compounds.

### BACKGROUND OF THE INVENTION

At present, the patents of core-shell structured catalysts are almost focused on the structural analysis and application thereof. For an example, a Taiwan patent No. I240009 disclosed a method for synthesizing a metallic core-shell structured nanocomposite particle, which comprises steps: providing several metal salts respectively having different reduction reaction rates, and preparing an aqueous solution of the metal salts; adding a solution of sodium citrate and tannic acid as a reducing agent to the aqueous solution; controlling the reduction reaction to undertake at an appropriate temperature for an appropriate interval of time to make the metal having higher reduction reaction rates form a core and the metals having lower reduction rates and the metals having higher reduction rates jointly form an alloy shell. Thereby is obtained a metallic core-shell structured nanocomposite particle.

For another example, a Taiwan patent No. I264326 disclosed a method for fabricating a metallic core-shell structured nanocomposite functioning as a photocatalyst, which comprises steps: forming a solution of TiO₂ nanoparticles; adding to the solution a multi-functional group compound having a first functional group and a second functional group to make the TiO₂ nanoparticles join to the first functional groups; and adding metallic nanoparticles to the solution to let the metallic nanoparticles covalently bond with the second functional groups.

Therefore, the conventional technology still has room to improve because it has not so far disclosed the fabrication of the gold/titanium dioxide core-shell structured photocatalyst and the application thereof to the decomposition of organic compounds but only pays attention to the structural analysis and application of core-shell structured catalysts.

### SUMMARY OF THE INVENTION

The primary objective of the present invention is to provide a method for fabricating a gold/titanium dioxide core-shell structured photocatalyst.

Another objective of the present invention is to provide a method of using a gold/titanium dioxide core-shell structured photocatalyst to fast decompose organic compounds and dyes under ultraviolet irradiation.

To achieve the abovementioned objectives, the present invention proposes a method for fabricating a gold/titanium dioxide core-shell structured photocatalyst, which comprises steps: using a chemical reduction method to fabricate a mixture of gold and titanium dioxide by a ratio of 0.002 to 0.1, wherein a solution of CTAB (cetyltrimethylammonium bromide) is added to a solution of chloroauric acid to form a first solution, and a solution of Vitamin C is dripped into the first solution agitated rapidly at an ambient temperature to form a second solution; slowly dripping an alcohol solution of TTIP (titanium isopropoxide) into the second solution to form a third solution, and agitating the third solution for several minutes to form a suspension liquid containing gold nanoparticles and titanium dioxide nanoparticles; performing a condensate recirculation process on the suspension liquid to maintain the reaction at a temperature of 65-85° C. for 1-3 hours, wherein a condenser is arranged above the reactor to condense the vapor into liquid and recirculate the liquid to the reactor; using a hydrothermal method to heat the suspension liquid to a temperature of 150-200° C. for 8-20 hours to form a powder of a gold/titanium dioxide core-shell structured photocatalyst; centrifugally removing the solvent from the mixture of the powder and the solvent; and baking the powder at a temperature of 30-80° C.

### BRIEF DESCRIPTION OF THE DRAWINGS

FIG. 1 shows the spectra of 0.0 wt. % Au@TiO₂ (a), 0.5 wt. % Au@TiO₂ (b), 1.0 wt. % Au@TiO₂ (c), and, 2.0 wt. % Au@TiO₂, which are fabricated according to a method of the present invention;

FIG. 2A shows the TEM image of 0.5 wt. % Au@TiO₂ fabricated according to a method of the present invention;

FIG. 2B shows the TEM image of 1.0 wt. % Au@TiO₂ fabricated according to a method of the present invention;

FIG. 2C shows the TEM image of 2.0 wt. % Au@TiO₂ fabricated according to a method of the present invention; and

FIG. 3 shows decomposition rates of methylene blue photocatalytically decomposed by Au@TiO₂ respectively having different proportions of gold.

### DETAILED DESCRIPTION OF THE PREFERRED EMBODIMENTS

### Embodiments of Fabrication

The present invention uses a chemical reduction method to fabricate a gold-titanium dioxide nanocomposite catalyst, wherein gold and titanium dioxide may be mixed by different ratios. The Au@TiO₂ nanoparticle of the present invention is fabricated via three steps:
(1) Using a chemical reduction method to fabricate a solution of gold ions: add a solution of CTAB (cetyltrimethylammonium bromide) to a solution of chloroauric acid (HAuCl₄) to form a first solution; rapidly agitate the first solution for several minutes, and drip a solution of Vitamin C to the first solution to form a second solution at an ambient temperature during agitation; agitate the second solution for 5-30 minutes to complete the reaction (in this step, the liquid turns from transparent to purple);
(2) Using a sol-gel method to form a titanium-dioxide shell: slowly drip an appropriate amount of an alcohol solution of TTIP (titanium isopropoxide) into the second solution to form a third solution; agitate the third solution for 5-10 minutes to form a suspension liquid containing gold nanoparticles and titanium dioxide nanoparticles; perform a condensate recirculation process on the suspension liquid at a temperature of 65-85° C. to control the reaction to proceed at a specified temperature, wherein a condenser is arranged above the reactor to condense the vapor into liquid and recirculate the liquid to the reactor for 0.5-3.0 hours;
(3) Crystallizing the Au@TiO₂ core-shell structured nanoparticles: use a hydrothermal method (a wet chemical method undertaking a reaction in an airtight container at a given temperature and under a given pressure) to heat the suspension liquid to a temperature of 150-200° C. hydrothermally for 8-20 hours to form an Au@TiO₂ powder; centrifugally remove the solvent from the mixture of the powder and the solvent; and bake the powder at a temperature of 30-80° C.

### General Description of the Experiments

Element analysis: the content of gold is analyzed with ICP-MS (PE-SCIEX ELAN 6100 DRC).

Nanoparticle analysis: the crystalline structure of nanoparticles are analyzed with an X-ray diffractometer (XRD Simens D-500 powder diffractometer with Cu K_{α1} radiation) and observed with a transmission electron microscope (TEM JEM-2000 EX II).

### Embodiment I

### Synthesis of 0.5 wt. % Au@TiO₂

1. Using a chemical reduction method to fabricate a solution of gold ions: add a solution of CTAB (1 mM, 20 ml) to a solution of HAuCl₄ (0.54 mM, 20.00 ml) to form a first solution; rapidly agitate the first solution for 2-3 minutes, and drip a solution of Vitamin C (1.08 mM, 20.00 ml) to the first solution to form a second solution at an ambient temperature during agitation; agitate the second solution for 15 minutes to complete the reaction.
2. Using a sol-gel method to form a titanium-dioxide shell: slowly drip an alcohol solution of TTIP (174 mM, 30.5 ml) into the second solution to form a third solution; agitate the third solution for 5-10 minutes to form a suspension liquid containing gold nanoparticles and titanium dioxide nanoparticles; perform a condensate recirculation process on the suspension liquid at a temperature of 75-85° C. to control the reaction to proceed at a specified temperature, wherein a condenser is arranged above the reactor to condense the vapor into liquid and recirculate the liquid to the reactor for about 2 hours.
3. Crystallizing the Au@TiO₂ core-shell structured nanoparticles: use a hydrothermal method to heat the suspension liquid to a temperature of 180° C. for 18 hours to form an Au@TiO₂ powder; centrifugally remove the solvent from the mixture of the powder and the solvent; and bake the powder at a temperature of 50° C.

### Examination of the Nanoparticles:

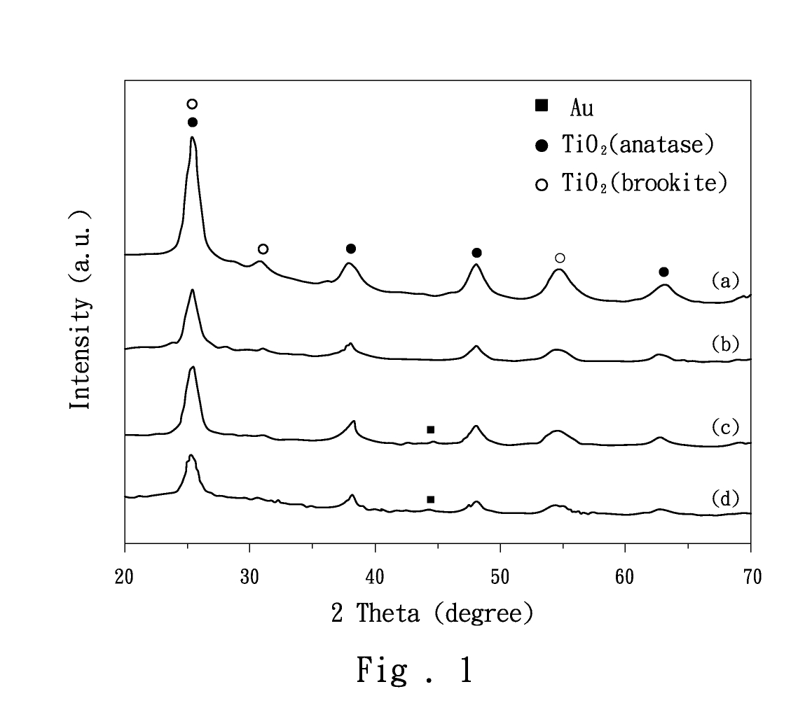

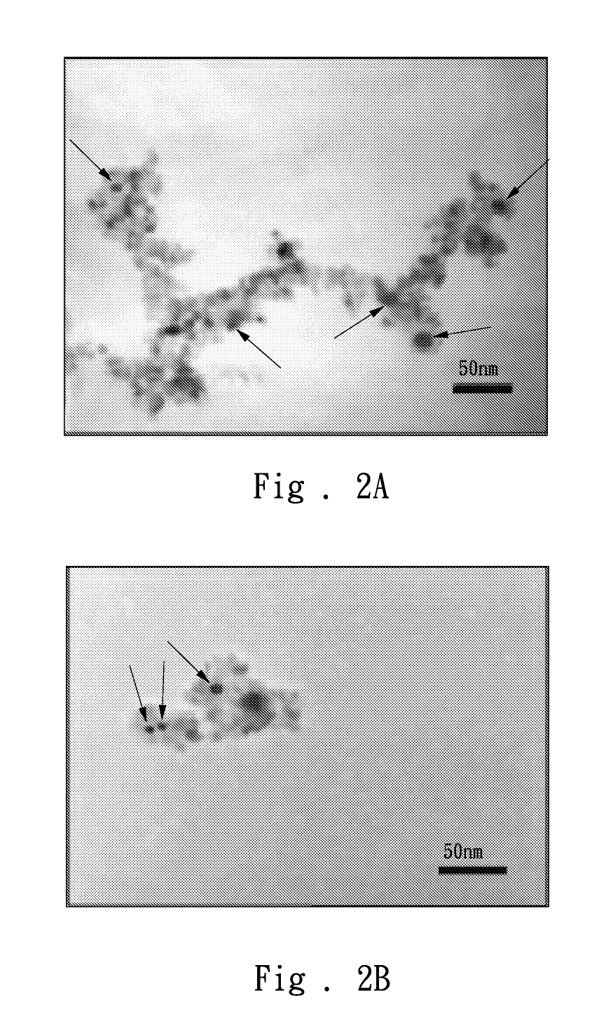

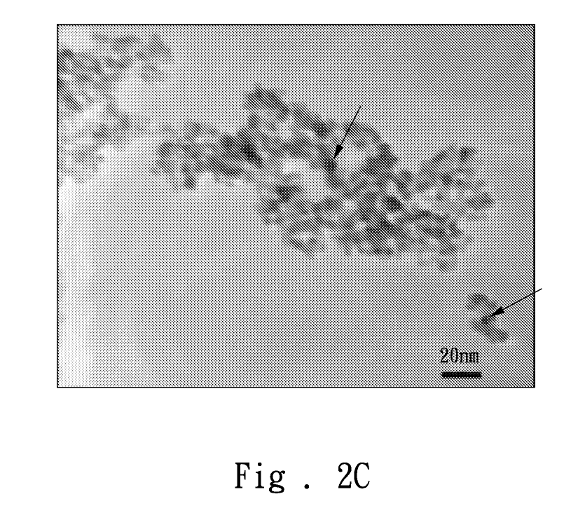

FIG. 1 shows the spectra of Au@TiO₂. Curve (a) in FIG. 1 is the XRD (X-ray diffractometry) spectrum of 0.0 wt. % Au@TiO₂ (free of gold cores), and Curve (b) in FIG. 1 is the XRD spectrum of 0.5 wt. % Au@TiO₂. FIG. 2A shows the TEM image of 0.5 wt. % Au@TiO₂.

The size of the particles of the TiO₂ crystal is 8.3 nm (by XRD). The size of the gold nanoparticles is 5-10 nm by TEM.

The content of gold in Au@TiO₂ is 0.5 wt % by calculation and 0.48 wt % by ICP-MS.

### Embodiment II

### Synthesis of 1.0 wt. % Au@TiO₂

1. Using a chemical reduction method to fabricate a solution of gold ions: add a solution of CTAB (1 mM, 20.00 ml) to a solution of HAuCl₄ (1.08 mM, 20 ml) to form a first solution; rapidly agitate the first solution for 2-3 minutes, and drip a solution of Vitamin C (2.16 mM, 20.00 ml) to the first solution to form a second solution at an ambient temperature during agitation; agitate the second solution for 15 minutes to complete the reaction.
2. Using a sol-gel method to form a titanium-dioxide shell: slowly drip an alcohol solution of TTIP (174 mM, 30.5 ml) into the second solution to form a third solution; agitate the third solution for 5-10 minutes to form a suspension liquid containing gold nanoparticles and titanium dioxide nanoparticles; perform a condensate recirculation process on the suspension liquid at a temperature of 75-85° C. to control the reaction to proceed at a specified temperature, wherein a condenser is arranged above the reactor to condense the vapor into liquid and recirculate the liquid to the reactor for about 2 hours.
3. Crystallizing the Au@TiO₂ core-shell structured nanoparticles: use a hydrothermal method to heat the suspension liquid to a temperature of 180° C. for 18 hours to form an Au@TiO₂ powder; centrifugally remove the solvent from the mixture of the powder and the solvent; and bake the powder at a temperature of 50° C.

### Examination of the Nanoparticles:

Curve (c) in FIG. 1 is the XRD spectrum of 1.0 wt. % Au@TiO₂. FIG. 2B shows the TEM image of 1.0 wt. % Au@TiO₂, wherein the particles of the TiO₂ crystals are indicated by arrows and have a size of 8.1 nm (by XRD). The size of the gold nanoparticles (the cores) is 5-10 nm (by TEM). The content of gold in Au@TiO₂ is 1.0 wt % by calculation and 0.95 wt % by ICP-MS.

### Embodiment III

### Synthesis of 2.0 wt. % Au@TiO₂

1. Using a chemical reduction method to fabricate a solution of gold ions: add a solution of CTAB (1 mM, 20.00 ml) to a solution of HAuCl₄ (1.08 mM, 20 ml) to form a first solution; rapidly agitate the first solution for 2-3 minutes, and drip a solution of Vitamin C (4.32 mM, 20.00 ml) to the first solution to form a second solution at an ambient temperature during agitation; agitate the second solution for 15 minutes to complete the reaction.
2. Using a sol-gel method to form a titanium-dioxide shell: slowly drip an alcohol solution of TTIP (174 mM, 30.5 ml) into the second solution to form a third solution; agitate the third solution for 5-10 minutes to form a suspension liquid containing gold nanoparticles and titanium dioxide nanoparticles; perform a condensate recirculation process on the suspension liquid at a temperature of 75-85° C. to control the reaction to proceed at a specified temperature, wherein a condenser is arranged above the reactor to condense the vapor into liquid and recirculate the liquid to the reactor for about 2 hours.
3. Crystallizing the Au@TiO₂ core-shell structured nanoparticles: use a hydrothermal method to heat the suspension liquid to a temperature of 180° C. for 18 hours to form an Au@TiO₂ powder; centrifugally remove the solvent from the mixture of the powder and the solvent; and bake the powder at a temperature of 50° C.

### Examination of the Nanoparticles:

Curve (d) in FIG. 1 is the XRD spectrum of 2.0 wt. % Au@TiO₂. FIG. 2C shows the TEM image of 2.0 wt. % Au@TiO₂, wherein the particles of the TiO₂ crystals are indicated by arrows and have a size of 8.4 nm (by XRD). The size of the gold nanoparticles (the cores) is 5-10 nm (by TEM). The content of gold in Au@TiO₂ is 2.0 wt % by calculation and 1.93 wt % by ICP-MS.

### EMBODIMENTS OF APPLICATION

Place the Au@TiO₂ obtained in the embodiments of fabrication in an aqueous solution of a dye and illuminate the aqueous solution with ultraviolet ray.

### Embodiment IV

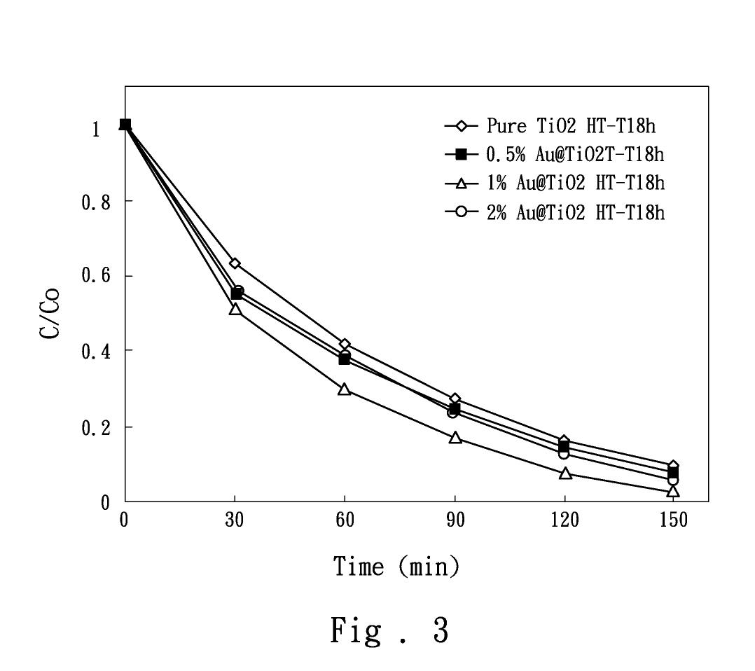

1. Place the catalyst 0.02 g of the powder of 0.5 wt % Au@TiO₂ in a dish to undertake a photocatalytic descomposition of methylene blue (MB) (200 ml, 10 ppm).
2. Use two pieces of 8 w 254 nm ultraviolet tube lamps to illuminate the solution, and sample the solution each 30 minutes; use an ultraviolet-visible spectrometer to analyze the samples with the scanning wavelength ranging from 200 to 800 nm. The detection result of the decomposition of methylene blue is shown below, and the decomposition rate is shown in FIG. 3.

The decomposition rate of methylene blue (MB) is defined as follows:

Decomposition rate of MB=MB concentration at a specified time point/original MB concentration

time (min)

| | 0 | 30 | 60 | 90 | 120 | 150 |
|---|---|---|---|---|---|---|
| C/C₀ | 1.000 | 0.558 | 0.395 | 0.238 | 0.168 | 0.069 |

### Embodiment V

1. Place the catalyst 0.02 g of the powder of 1.0 wt % Au@TiO₂ in a dish to undertake a photocatalytic descomposition of methylene blue (200 ml, 10 ppm).
2. Use two pieces of 8 w 254 nm ultraviolet tube lamps to illuminate the solution, and sample the solution each 30 minutes; use an ultraviolet-visible spectrometer to analyze the samples with the scanning wavelength ranging from 200 to 800 nm. The detection result of the decomposition of methylene blue is shown below, and the decomposition rate is shown in FIG. 3.

The decomposition rate of methylene blue (MB) is defined as follows:

Decomposition rate of MB=MB concentration at a specified time point/original MB concentration

time(min)

| | 0 | 30 | 60 | 90 | 120 | 150 |
|---|---|---|---|---|---|---|
| C/C₀ | 1.000 | 0.492 | 0.295 | 0.162 | 0.049 | 0.022 |

### Embodiment VI

1. Place the catalyst 0.02 g of the powder of 2.0 wt % Au@TiO₂ in a dish to undertake a photocatalytic descomposition of methylene blue (200 ml, 10 ppm).
2. Use two pieces of 8 w 254 nm ultraviolet tube lamps to illuminate the solution, and sample the solution each 30 minutes; use an ultraviolet-visible spectrometer to analyze the samples with the scanning wavelength ranging from 200 to 800 nm. The detection result of the decomposition of methylene blue is shown below, and the decomposition rate is shown in FIG. 3.

The decomposition rate of methylene blue (MB) is defined as follows:

Decomposition rate of MB=MB concentration at a specified time point/original MB concentration

time (min)

| | 0 | 30 | 60 | 90 | 120 | 150 |
|---|---|---|---|---|---|---|
| C/C₀ | 1.000 | 0.556 | 0.294 | 0.230 | 0.160 | 0.045 |

### Comparison:

1. Place 0.02 g of the powder of gold-free 0.0 wt % Au@TiO₂ (pure TiO₂) in a dish to undertake a photocatalytic descomposition of methylene blue (200 ml, 10 ppm).
2. Use two pieces of 8 w 254 nm ultraviolet tube lamps to illuminate the solution, and sample the solution each 30 minutes; use an ultraviolet-visible spectrometer to analyze the samples with the scanning wavelength ranging from 200 to 800 nm. The detection result of the decomposition of methylene blue is shown below, and the decomposition rate is shown in FIG. 3.

The decomposition rate of methylene blue (MB) is defined as follows:

Decomposition rate of MB=MB concentration at a specified time point/original MB concentration

time (min)

| | 0 | 30 | 60 | 90 | 120 | 150 |
|---|---|---|---|---|---|---|
| C/C₀ | 1 | 0.626 | 0.433 | 0.290 | 0.180 | 0.101 |

The above experimental results prove that the catalyst fabricated by the present invention can decompose the dye in waste water more effectively than pure TiO₂ (gold-free 0.0 wt % Au@TiO₂).

What is claimed is:

1. A method for fabricating a gold/titanium dioxide core-shell structured photocatalyst, comprising steps:
fabricating a mixture of gold and titanium dioxide by a weight ratio of 0.002 to 0.1 by a chemical reduction method, wherein an appropriate amount of a solution of CTAB (cetyltrimethylammonium bromide) is added to a solution of chloroauric acid to form a first solution, and a solution of Vitamin C is dripped into the first solution agitated rapidly at an ambient temperature to form a second solution;
slowly dripping an appropriate amount of an alcohol solution of TTIP (titanium isopropoxide) into the second solution to form a third solution, and agitating the third solution for several minutes to form a suspension liquid containing gold nanoparticles and titanium dioxide nanoparticles;
condensating and recirculating the suspension liquid to maintain reaction at a temperature of 65-85° C. for 1-3 hours, wherein a condenser is arranged above a reactor to condense vapor into liquid and recirculate the liquid to the reactor, and using a hydrothermal method to heat the condensed liquid to a temperature of 150-200° C. for 8-20 hours to form a powder of a gold/titanium dioxide core-shell structured photocatalyst; and
centrifugally removing a solvent from the condensed liquid containing the powder, and baking the powder at a temperature of 30-80° C.

2. A method for using the gold/titanium dioxide core-shell structured photocatalyst according to claim 1 to decompose organic compounds under ultraviolet irradiation, wherein a powder of the gold/titanium dioxide core-shell structured photocatalyst is used to decompose organic compounds under ultraviolet irradiation.

3. The method according to claim 2, wherein one of the organic compounds is methylene blue.
